(19) United States
(12) Patent Application Publication
(10) Pub. No.: US 2006/0281437 A1
(43) Pub. Date: Dec. 14, 2006

(54) Systems and methods for supporting E911 emergency services in a data communications network

(75) Inventor: Charles I. Cook, Louisville, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 11/152,024

(22) Filed: Jun. 13, 2005

(51) Int. Cl. H04M 11/04

(52) U.S. Cl. 455/404.2; 379/45; 379/88.17; 455/411

(57) ABSTRACT

The present invention provides systems and methods for supporting enhanced 911 (E911) emergency services in data communications networks that includes Voice over Internet Protocol (VoIP) telephones, by facilitating the identification of the geographic location of a VoIP telephone. The invention generally provides GPS-based geographic location information to the E911 emergency services network. In one embodiment, an E911-enablement system including an E911-enablement device coupled to a GPS receiver is provided. The E911-enablement device then inserts geographic location information obtained from the GPS receiver into 911 call packet streams to provide accurate location information to the E911 emergency services network.

### BACKGROUND OF THE INVENTION

The present invention is generally directed to Voice over Internet Protocol (VoIP) telephony. In particular, the present invention is directed to supporting enhanced 911 (E911) emergency services in a data communications network that includes VoIP telephones.

Voice over Internet Protocol (VoIP) refers to a standardized set of facilities for managing the delivery of voice information using the Internet Protocol (IP). In IP telephony, voice information is transmitted in discrete packets over shared bandwidth, rather than over the circuit driven protocol used by the traditional Public Switched Telephone Network (PSTN) and traditional plain old telephone service (POTS).

VoIP offers added flexibility over POTS. For instance, like a laptop computer, a VoIP telephone can be easily moved from one point of network access to another without the assistance of a telephony administrator, and without having to change its identifying characteristics. Such identifying characteristics may include a telephone number, an IP address, and/or a media access control (MAC) address. While such ease of access may be desirable from an end user perspective, it creates significant concerns from the perspective of providing mission critical services such as enhanced emergency services, also known as E911.

By way of background, the 3-digit telephone number 911 has been designated for public use throughout the United States and Canada to report an emergency, request emergency assistance, or both. By dialing 911, a person is provided direct access to a Public Safety Answering Point (PSAP). A PSAP is an agency or group of agencies designated and authorized to receive and respond to emergency calls requiring one or more public services, such as Police, Fire or Emergency Medical Service. Because the 911 number does not change, and there are thousands of PSAP's in the United States and Canada, it is vital that 911 calls are routed to the appropriate PSAP—i.e., the one closest to the location where the call originates. Traditionally, before the advent of mobile telephones, a telephony administrator, normally working for the local telephony service provider, automatically routed calls from a fixed telephone to the nearest PSAP. Because a telephony administrator was required to move a user's extension from one location to another, the administrator could also ensure proper routing of 911 calls.

With the advent of mobile telephones, a new system was necessary. This led to the advent of enhanced emergency services, or enhanced 911 (E911). The main characteristic of E911 service is the capability to selectively route a 911 call originating from any device (mobile and fixed alike) in the E911 service area to the correct PSAP designated to serve the originating devices' location. Another key feature of E911 is that it also provides the PSAP operator with the location of the calling device and a callback number. These enhanced features are implemented primarily through the use of Selective Routing (SR), and maintenance of an Automatic Location Identification (ALI) database. Selective Routing refers to the routing of a 911 call to the proper PSAP based upon the location of the caller. The ALI database, which is regularly updated to match telephone numbers to physical locations, works within a database management system (DBMS) to automatically provide the PSAP operator the physical location of the calling device and a callback number.

The ability to support E911 services is mandated in many states. In a VoIP environment, it is possible for a user to successfully move their IP phone from one network access point to another without notifying the telephony administrator. In this case, the telephony administrator would be unable to update the ALI database with the new location of the user and as a result, the ALI database would not contain the new location of that user.

The ability to provide physical location information to update the E911 service database is available for VoIP deployment, but many conventional solutions are proprietary, and require the user to choose the same vendor to provide, upgrade, and replace key system components. The concern with this approach is that it does not allow users to take advantage of industry innovations. Instead, customers are forced to rely on products from a single vendor. Other approaches require mapping of network access points, which may result in a lag time if new access points are added without proper mapping.

It would be beneficial, then, to provide improved support of E911 emergency services in a data communications network by efficiently updating an ALI database each time a user changes the location of a VoIP telephone within the network or each time a 911 call is placed via a VoIP telephone.

### BRIEF SUMMARY OF THE INVENTION

The present invention generally relates to systems and methods that substantially obviates one or more of the problems and disadvantages of the related art. In particular, the present invention is directed to systems and methods for supporting enhanced 911 (E911) emergency services in a data communications network by facilitating the identification of a geographic location, i.e., physical location, of a VoIP telephone.

In a first aspect, a method for supporting enhanced 911 (E911) emergency service in a data communications network is provided. The method generally comprises: (a) providing an E911-enablement device coupled to a GPS receiver, wherein said E911-enablement device is located in-line between a Voice over Internet Protocol (VoIP) telephone and a network access point. The E911-enablement device: (i) detects a 911 call; (ii) intercepts said 911 call packet stream, (iii) receives geographic location information from the GPS receiver, and (iv) inserts the geographic location information into the 911 call packet stream. The method then comprises: (b) transmitting the 911 call packet stream comprising the geographic location information to a Public Safety Answering Point (PSAP) of the E911 emergency service, thereby permitting the E911 emergency service to identify the geographic location of origination of the 911 call.

In one embodiment, following detection of the 911 call, but prior to transmission of the 911 call packet stream to the PSAP, the E911-enablement device further: authenticates the VoIP telephone, wherein the authentication comprises receiving a unique device identifier related to the VoIP telephone, and inserts the unique device identifier into the 911 call packet stream.

In another aspect of the invention, a method for supporting enhanced 911 (E911) emergency service in a data communications network is provided. The method generally comprises: (a) providing an E911-enablement device coupled to a GPS receiver, wherein the E911-enablement device is located in-line between a VoIP telephone and a network access point. The E911-enablement device: (i) detects the VoIP telephone coupled to the network access point through the E911-enablement device; (ii) authenticates the VoIP telephone, wherein said authenticating comprises receiving a unique device identifier related to the VoIP telephone, and (iii) receives geographic location information from the GPS receiver. The method then comprises: (b) transmitting the unique device identifier and the geographic location information to an E911 database management system, thereby permitting the E911 database management system to store the geographic location information in association with the unique device identifier to identify the geographic location of the VoIP telephone.

In yet another aspect of the invention, an E911-enablement system is provided. The E911-enablement system generally comprises an E911-enablement device coupled to a GPS receiver. The E911-enablement device includes (a) at least one input port adapted for interfacing with a VoIP telephone; (b) at least one output port adapted for interfacing with a network access point; and (c) control logic including computer implementable code for: receiving geographic location information from the GPS receiver; and transmitting at least the geographic location information to the outlet port for communication through the network access point.

In one embodiment, the computer implementable code is further for: detecting a 911 call; intercepting a 911 call packet stream; inserting the geographic location information in the 911 call packet stream; and transmitting the 911 call packet stream including the geographic location information to the outlet port for communication through the network access point.

In another embodiment, the computer implementable code is further for: detecting and authenticating a VoIP telephone, wherein the authentication comprises receiving a unique device identifier related to the VoIP telephone; and transmitting at least the unique device identifier to the outlet port for communication through the network access point.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 illustrates the basic elements of an exemplary data communications system.

FIG. 2 illustrates an exemplary architecture of an enhanced 911 (E911) enablement system in accordance with an embodiment of the present invention, with optional aspects indicated in dashed lines.

FIG. 3 illustrates an exemplary architecture of a Voice over Internet Protocol (VoIP) telephone in accordance with an embodiment of the present invention.

FIG. 4 illustrates an exemplary method for supporting enhanced 911 (E911) emergency services in a data communications network that includes VoIP telephones in accordance with an embodiment of the present invention, with optional steps indicated in dashed lines.

FIG. 5 illustrates another exemplary method for supporting enhanced 911 (E911) emergency services in a data communications network that includes VoIP telephones in accordance with an embodiment of the present invention.

### DETAILED DESCRIPTION OF THE INVENTION

The present invention provides systems and methods for supporting enhanced 911 (E911) emergency services in data communications networks that include Voice over Internet Protocol (VoIP) telephones, by facilitating the identification of the geographic location, i.e., physical location, of a VoIP telephone. The invention generally provides GPS-based geographic location information to the E911 emergency services network. The geographic location information may include any suitable geographic location information obtainable from the GPS system, including latitude/longitude, street address, standard map reference location, etc.

Generally, in accordance with one aspect of the invention, a host network may comply with E911 requirements using a standards-based approach that is independent of proprietary technologies used by the host network. Specifically, information obtained from a VoIP telephone by an E911-enablement system during execution of a standard user authentication protocol is coupled with geographic location information obtained from a GPS receiver to automatically update an Automatic Location Information (ALI) database of the E911 vendor. Such an automatic update provides geographic location details for each VoIP telephone connected to the host network. In a preferred embodiment, information obtained during execution of a user authentication protocol in accordance with the IEEE 802.1x standard is used to comply with E911 requirements.

An alternate embodiment allows a host network to comply with E911 requirements using an industry standard protocol that facilitates the automatic exchange of management information between network devices. Preferably, the Simple Network Management Protocol (SNMP) is used to automatically provide comprehensive location details for each VoIP telephone connected to the host network directly to the E911 database management system 137 of the E911 vendor.

In another aspect, an E911-enablement system is provided comprising an E911-enablement device coupled to a GPS receiver. By way of example, in one embodiment, the E911-enablement device then inserts geographic location information obtained from the GPS receiver into 911 call packet streams to provide accurate location information to the E911 emergency services network.

These and other aspects and embodiments will be described in further detail below.

I. Exemplary Operating Environment

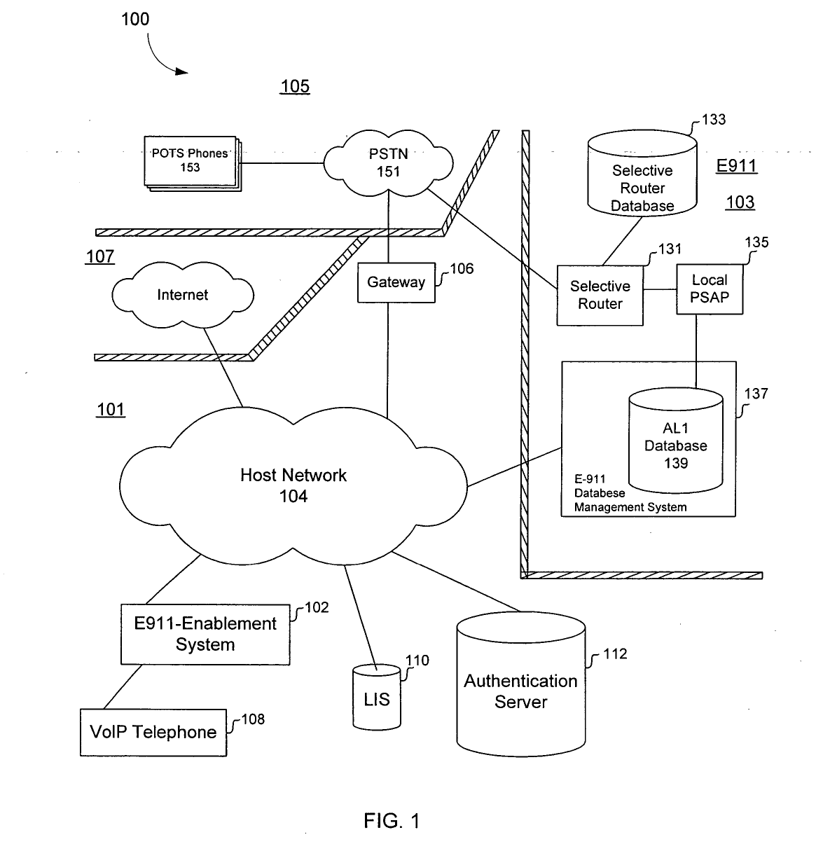

FIG. 1 depicts the basic elements of an exemplary voice and data communications system 100 in which an embodiment of the present invention may operate. As shown in FIG. 1, system 100 comprises a local data communications network 101, which is communicatively coupled to an E911 network 103, a public telephone network 105, and the Internet 107. These networks and devices included therein are described in more detail herein.

Local data communications network 101 comprises a plurality of network nodes interconnected via a wired and/or wireless medium. Each node consists of a device capable of transmitting or receiving data over a host network 104. As shown in FIG. 1, local data communications network 101 comprises host network 104, an E911-enablement system in accordance with the present invention 102 communicatively coupled to host network 104 via a network access port (not shown), and a VoIP telephone 108 communicatively coupled to E911-enablement system 102. VoIP telephone 108 may be communicatively coupled to E911-enablement system 102 via any suitable means known in the art, including wired and wireless medium. Local data communications network 101 also includes a local identification server (LIS) 110, an authentication server 112, and a gateway 106 to public telephone network 105.

In the embodiment described herein, host network 104 comprises a conventional local area network (“LAN”) that employs an Ethernet communication protocol in accordance with the IEEE 802.3 standard for data link and physical layer functions. However, the invention is not so limited, and host network 104 may comprise other types of networks, including but not limited to a wide area network (“WAN”), and other types of communication protocols, including but not limited to ATM, token ring, ARCNET, or FDDI (Fiber Distributed Data Interface) protocols.

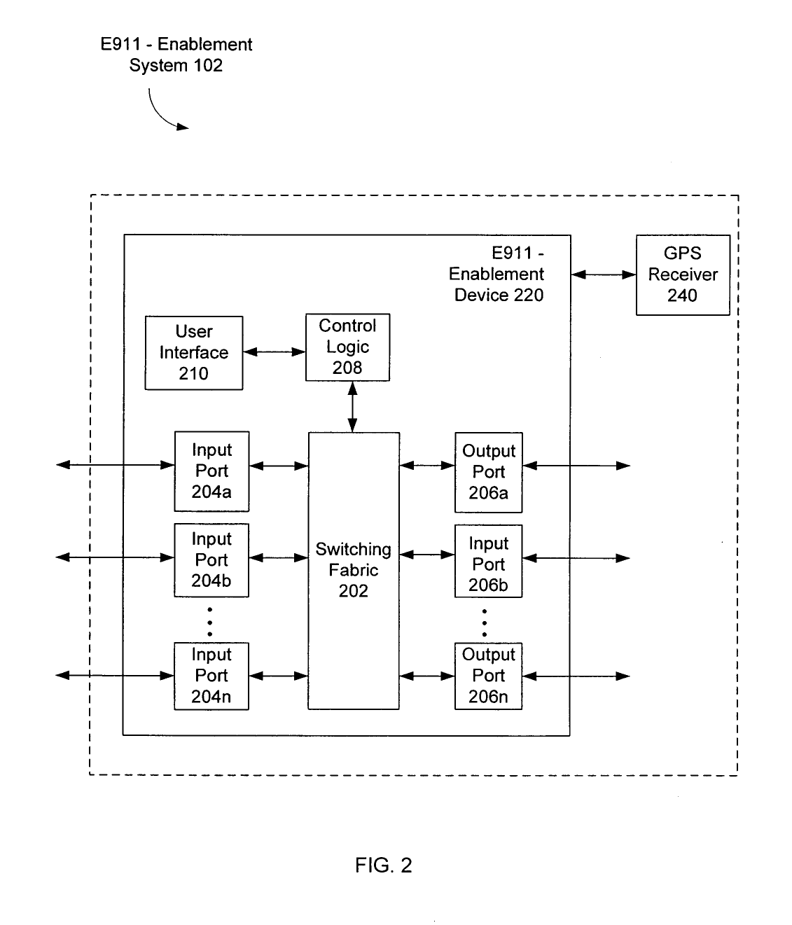

E911-enablement system 102, which preferably comprises a network switch, is a device that comprises a plurality of ports for communicatively interconnecting network device(s) to host network 104 and each other (if multiple devices are present). E911-enablement system 102 is configured to channel data units, such as data packets or frames, between device(s) that are attached to it and host network 104, up to its maximum number of ports. For instance, E911-enablement system 102 may examine each received data unit and, based on a destination address included therein, determine which network device (or host network) the data unit is intended for and switches it out toward that device. E911-enablement system 102 is described in more detail herein with respect to FIG. 2.

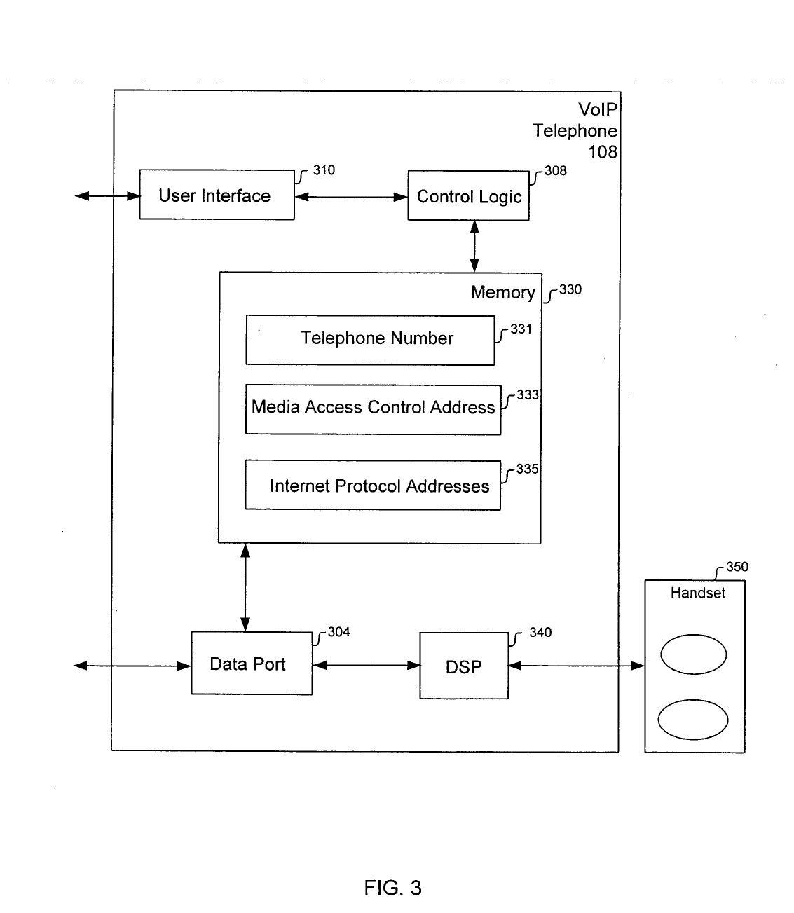

As depicted in FIG. 1, VoIP telephone 108 is communicatively coupled to one of the ports of E911-enablement system 102. As will be appreciated by persons skilled in the relevant art(s), VoIP telephone 108 enables a user to place and receive VoIP telephone calls via local data communications network 104. VoIP telephone 108 is described in more detail herein with respect to FIG. 3.

Authentication server 112 comprises a computer that stores application software and a database of profile information for performing a user authentication protocol, such as a user authentication protocol in accordance with the IEEE 802.1x standard. In an embodiment, authentication server 112 comprises a server that uses the Remote Authentication Dial-In User Service (RADIUS) as set forth in Internet Engineering Task Force (IETF) Request For Comments (RFC) 2865 for performing user authentication functions.

Local identification server (LIS) 110 is a device administered by the host network administrator. LIS 110 is configured with data that provides an association between physical port connections and location information. LIS 110 permits a network administrator to collect and store a complete host network 104 infrastructure inventory, including VoIP device addresses (MAC and IP). In accordance with certain embodiments of the invention, this information can then be used to feed an E911 database management system 137 with device identification information. Once the inventory has been collected, the E911 database management system 137 can use industry-standard Structured Query Language (SQL) in the determination of the location of VoIP telephones. Alternatively, Simple Network Management Protocol (SNMP) can be used to determine the location of VoIP telephones.

II. Enhanced 911 (E911) Network

Enhanced 911 (E911) network 103 is an example of a conventional E911 network, the structure and function of which are well-known in the art. As shown in FIG. 1, E911 network 103 comprises a selective router 131 and a local Public Service Answering Point (PSAP) 135. Selective router 131 (also referred to as an enhanced 911 control office) is communicatively coupled to a selective router database 133. In traditional communication network systems, selective router 131 uses selective router database 133 to provide for the tandem switching of 911 calls and to ensure the routing of a 911 call to the proper PSAP along with an automatic number identification (ANI). The ANI is the telephone number associated with the access line from which a call originates. Selective router 131 also provides certain maintenance functions for each PSAP.

Local PSAP 135 is communicatively coupled to an Automatic Location Identification (ALI) database 139. ALI database 139 is a database that uniquely correlates an ANI with a physical location for each telephone connected to the local network. Once a 911 call is routed to local PSAP 135, local PSAP 135 communicates with ALI database 139 to automatically display the physical location and telephone number of the telephone being used to make the 911 call. Such information allows the PSAP operator to direct the requested services to the proper location, and allows the PSAP operator to call back in the event the connection is lost, or more information is needed. ALI database 139 also provides supplementary emergency services information.

An E911 database management system 137 keeps the data stored in ALI database 139 up-to-date. Typically, the E911 database management system 137 uses the Transmission Control Protocol/Internet Protocol (TCP/IP) protocol suite to facilitate the exchange of information between network devices such as the local PSAP 135 and the ALI database 139. The TCP/IP protocol suite includes an application layer called the Simple Network Management Protocol (SNMP), which facilitates the automatic exchange of management information.

The task of ensuring that the data stored in the ALI database 139 is up-to-date is generally the responsibility of telephony administrators. This is typically accomplished via periodic updates from telephony administrators. Such an approach requires telephony administrators to have a complete awareness of the physical location of a given telephone at any point in time. Consequently, in a case where a user moves a VoIP telephone 108 from one point of network access to another without informing a telephony administrator, ALI database 139 may become out-of-date and, therefore, unreliable.

As will be described in more detail herein, an embodiment of the present invention addresses this problem by facilitating automatic updates of ALI database 139 in instances where a user moves a VoIP telephone 108 to a new point of network access. In another embodiment, the present invention provides up-to-date geographic location information in connection with a placed 911-call. In accordance with the methods of the present invention, the E911 Network and the ALI database are not dependent on physical location information based on ANI information alone, as in the convention approach.

III. Exemplary E911-Enablement System

FIG. 2 depicts an exemplary high-level architecture of E911-enablement system 102 in accordance with an embodiment of the present invention. As shown in FIG. 2, E911-enablement system 102 comprises E911-enablement device 220 coupled to GPS receiver 240. GPS receiver 240 may be coupled to E911-enablement device 220 in any suitable manner known in the art such that GPS receiver 240 is in communication with E911-enablement device 220. By way of example, GPS receiver 240 may be remotely located from E911-enablement device 220, and in communication with E911-enablement device 220 via conventional wired or wireless medium (e.g., via an input port). In such a configuration, GPS receiver 240 may be positioned near, e.g., an exterior window or wall such that it has a clear line-of-sight to at least one GPS satellite. In an alternative configuration, GPS receiver 240 may be integrated with E911-enablement device 220 (i.e., located within the same housing), as indicated by the dashed line in FIG. 2. In such a configuration, E911-enablement device 220 should be positioned such that it has a clear line-of-sight to at least one GPS-satellite. By “clear line-of-sight” is meant that the GPS receiver is able to receive an adequate signal from at least one GPS satellite such that it is able to receive accurate geographic location information.

Any suitable GPS receiver known in the art may be used. Alternative means of obtaining real-time geographic location information may be used, such as PCS/cellular network receivers, WiFi receivers, etc. As used herein, when reference is made to a GPS receiver, it should be understood that other means of obtaining real-time geographic location information could also be used.

In one embodiment, E911-enablement system 102 includes an indicator which indicates that status of GPS receiver 240 signal. By way of example, E911-enablement system 102 may include indicator LEDs that illuminates one status (e.g., green, solid, etc.) when GPS receiver 240 is receiving a strong GPS signal from at least one GPS satellite such that it is receiving geographic location information; a second status (e.g., amber, flashing, etc.) when GPS receiver 240 is receiving a broken signal from at least one GPS satellite such that it is receiving intermittent geographic location information; and a third status (e.g., red, off, etc.) when GPS receiver 240 is not receiving signal from at least one GPS satellite. The status indicator may further indicate the strength of signal (e.g., it may include signal strength bars, etc.). In one embodiment, the status indicator may be located on GPS receiver 240, or alternatively it may be located on E911-enablement device 220. Such status indicator may aid in placement of GPS receiver 240.

E911-enablement device 220 includes at least one input port(s), 204a-204n, that are coupled to at least one output port(s), 206a through 206n, via a switching fabric 202. E911-enablement device 220 also includes control logic 208 for controlling various aspects of operation of E911-enablement system 102, and an optional user interface 210 to facilitate communication with control logic 208. User interface 210 provides a means for a user, such as a system administrator, to reconfigure E911-enablement device 220 and adjust operating parameters.

In operation, data units (e.g., packets or frames) are received and optionally buffered on one or more of input ports 204a through 204n. In certain aspects, control logic 208 schedules the serving of data units received by input ports 204a-204n in accordance with a predetermined scheduling algorithm. Data units are then served to switching fabric 202, which routes them to the appropriate output port 206a-206n based on, for example, the destination address of the data unit. Output ports 206a-206n receive and optionally buffer data units from switching fabric 202, and then transmit them on to a destination device or host network 104. In accordance with an embodiment of the present invention, E911-enablement device 220 may also include logic 208 for performing routing functions.

In one embodiment, control logic 208 may be configured to receive geographic location information from GPS receiver 240. Control logic 208 may further be configured to route the geographic location information to a destination device or host network 104 in accordance with the invention. Alternatively, control logic 208 may be configured to detect and intercept 911 call data units (e.g., packet streams) and to insert the geographic location information into the intercepted 911 call packet streams. Control logic 208 may further be configured to route the 911 call packet stream with the inserted geographic location information to a destination device or host network 104. Such configurations may be achieved by computer implementable code input via, e.g., user interface 210.

Control logic 208 can also be configured to execute a user authentication protocol (e.g., IEEE 802.1x) whenever a device is coupled to one of the input ports 204a-204n or whenever a 911 call is detected. Control logic 208 can also be configured to support the TCP/IP protocol suite, which includes the SNMP application layer. Execution of a user authentication protocol and use of SNMP are described in more detail herein.

IV. Exemplary Voice over Internet Protocol (VoIP) Telephone

FIG. 3 depicts a VoIP telephone 108 in accordance with an embodiment of the present invention. However, the invention is not so limited, and any suitable VoIP telephone may be used. VoIP telephone 108 is adapted to transmit and receive data, including voice data, over a data communications network, such as host network 104. As shown in FIG. 3, VoIP telephone 108 includes a user interface 310 coupled to control logic 308, which is in turn coupled to a memory unit 330. Memory unit 330 interfaces with both control logic 308 and a data port 304, and is used to store identification information which includes a telephone number 331, a media access control (MAC) address 333 and an Internet Protocol (IP) address 335, each of which uniquely identifies VoIP telephone 108. VoIP telephone 108 further includes a digital signal processor (DSP) 340 and handset 350 that allow an analog voice signal to be relayed to and from data port 304 in digitized format in accordance with IP.

In accordance with an embodiment of the present invention, data port 304 of VoIP telephone 108 may be communicatively coupled to one of the input ports 204a-n of E911-enablement device 220 of E911-enablement system 102, as illustrated in FIG. 1. For example, VoIP telephone 108 may be coupled to an RJ-45 connector, which is in turn wired to an input port of E911-enablement device 220. VoIP telephone 108 is highly portable, and thus may be readily moved from one point of network access to another.

As described in more detail herein, control logic 308 of VoIP telephone 108 is advantageously configured to support a user authentication protocol such as, but not limited to, a user authentication protocol in accordance with the IEEE 802.1x standard. Thus, in an embodiment, when coupled to an input port 204a-204n of E911-enablement device 220, VoIP telephone 108 performs the role of an 802.1x supplicant seeking access to host network 104. In another embodiment, control logic 308 of VoIP telephone 108 is advantageously configured to support the TCP/IP protocol suite, of which the SNMP application layer is a part. These embodiments are explained more fully below. By supporting an industry standard user authentication protocol, or an industry standard management information protocol, VoIP telephone 108 provides increased flexibility in that it can be coupled to a wider variety of host networks. Use of industry standard protocols also confers other advantages in accordance with embodiments of the present invention, including the ability to more easily comply with E911 requirements.

V. Industry Standard Protocols

A. Authentication Protocol

An embodiment of the present invention uses industry standard protocols to automatically identify and retrieve identification information from a VoIP telephone 108 that is coupled to host network 104. In an embodiment, the IEEE 802.1x standard is used for this purpose. As will be appreciated by persons skilled in the relevant art(s), the 802.1x standard is a standard for port-based network access control for local and metropolitan area networks. Port-based network access control makes use of the physical access characteristics of IEEE 802™. Local Area Networks (LAN) infrastructures in order to provide a means of authenticating and authorizing devices attached to a LAN port that has point-to-point connection characteristics. The 802.1x standard is hereby incorporated by reference in its entirety.

The 802.1x standard encompasses a user authentication protocol. A Port Access Entity (PAE) exists for each port of a system that uses the 802.1x authentication protocol. The operation of the authentication process makes use of the Extensible Authentication Protocol (EAP), as specified in the Internet Engineering Task Force (IETF) Request For Comments (RFC) 2284. EAP provides a means for communicating authentication information between a PAE Supplicant (device being authenticated) and a PAE Authenticator (device doing the authenticating). Put differently, an Authenticator PAE is responsible for enforcing the authentication of a Supplicant PAE that is coupled to its controlled port, and for controlling the authorization state of the controlled port accordingly. Whether a device will be authenticated depends on the information stored in an Authentication Server, such as authentication server 112 depicted in FIG. 1.

EAP is a general protocol that supports multiple authentication mechanisms. For example, rather than only permitting a predetermined authentication method, EAP allows the Authenticator to request various types of information before determining the specific authentication mechanism. Examples of such information, called “request types,” include Identity, MD5-challenge, One-Time Passwords, and Generic Token Cart. Moreover, as part of the authentication protocol, statistical information regarding the current session associated with a port may be solicited. In order to solicit such information, each such session has a User-Name (dot1xAuthSessionUserName) that represents the identity of the Supplicant PAE.

In an embodiment of the present invention, VoIP telephone 108 is adapted to act as the Supplicant PAE, while E911-enablement device 220 or E911-enablement system 102 is adapted to act as the Authenticator PAE. In a preferred embodiment, VoIP telephone 108, is configured to provide the unique telephone number (or other unique device identifier) assigned to it as its User-Name during participation in the 802.1x user authentication protocol. As will be discussed in more detail below, this allows E911-enablement device 220 to link the unique device identifier assigned to VoIP telephone 108 with geographic location information received from GPS receiver 240 associated with VoIP telephone 108, such that this information can be automatically transmitted to E911 database management system 137 or, optionally, to LIS 110 prior to transmission to E911 database management system 137.

B. Network Management Information Protocol

Another embodiment of the present invention uses industry standard information management protocols to automatically send and retrieve identification information from a VoIP telephone 108 that is coupled to a host network. In an embodiment, the industry standard Simple Network Management Protocol (SNMP) is used for this purpose.

As will be appreciated by those skilled in the art, the SNMP is an application layer protocol that facilitates the exchange of management information between network devices. It is part of the Transmission Control Protocol/Internet Protocol (TCP/IP) protocol suite. SNMP enables network administrators to manage network performance, find and solve network problems, and plan for network growth.

An SNMP-managed network consists of three key components: managed devices, agents, and network-management systems (NMSs). A managed device is a network node that contains an SNMP agent and that resides in a managed network. Managed devices collect and store management information and make this information available to NMSs using SNMP. Managed devices can be routers, switches, hubs, E911-enablement device 220, or a VoIP telephone 108. An agent is a network-management software module that resides in a managed device. An agent has local knowledge of management information and translates that information into a form compatible with SNMP. An NMS executes applications that monitor and control managed devices. One or more NMSs must exist on any managed network.

There are four basic SNMP commands: read, write, trap and traversal operations. The read command is used by an NMS to monitor managed devices. The write command is used by an NMS to control managed devices by changing the value of variables stored therein. The trap command is used by managed devices to asynchronously report events to the NMS. When certain types of events occur, a managed device, such as E911-enablement device 220 or VoIP telephone 108, sends a trap to the NMS. Traversal operations are used by the NMS to determine which variables a managed device supports and to sequentially gather information in variable tables, such as a routing table.

Where VoIP telephone 108 and E911-enablement device 220 reside on an SNMP-managed network; SNMP can be leveraged to enable compliance with E911 requirements where the E911 database management system 137 is also an SNMP-managed network. More specifically, SNMP may be used to automatically update the E911 ALI database 139 when a VoIP user changes location within a network. Alternatively, SNMP may be used to route a 911 call packet stream including geographic location information to the E911 emergency service network. These embodiments are discussed in more detail below.

VI. Methods for Supporting Enhanced 911 (E911) Emergency Services

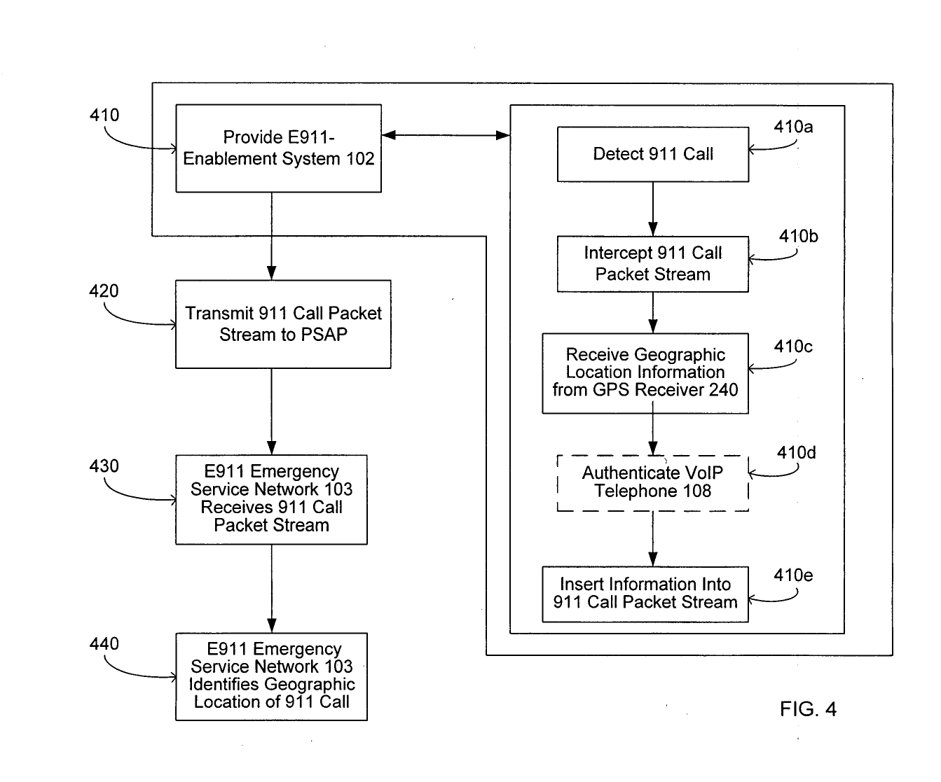

Now, turning to FIG. 4, method 400 for supporting enhanced 911 (E911) emergency service in a data communications network in accordance with an embodiment of the invention is illustrated. Method 400 will be described with reference to the operating system of FIG. 1 and E911-enablement system 102, however the method is not so limited, and various substitutions are envisioned. As shown in FIG. 4, block 410 involves providing E911-enablement system 102 comprising E911-enablement device 220 coupled to GPS receiver 240, wherein E911-enablement system 102 is located in-line between a Voice over Internet Protocol (VoIP) telephone 108 and a network access point in communication with host network 104. E911-enablement device 220 is configured so as to: detect a 911 call at block 410(a); intercept the 911 call packet stream at block 410(b), receive geographic location information from GPS receiver 240 at block 410(c), and insert the geographic location information into the 911 call packet stream at block 410(e). At block 410(d), E911-enablement device 220 may further authenticate VoIP telephone 108, wherein the authentication comprises receiving a unique device identifier related to VoIP telephone 108, and inserts said unique device identifier into said 911 call packet stream.

In one embodiment, the VoIP telephone may be authenticated using a standard authentication method described herein. By way of example, VoIP telephone 108 may be authenticated in accordance with the user authentication protocol. As part of the user authentication protocol, VoIP telephone 108 provides a unique device identifier to E911-enablement device 220. This unique device identifier may, e.g., comprise a physical (MAC) address 333 of VoIP telephone 108, an Internet Protocol (IP) address 335 of VoIP telephone 108, or a telephone number 331 of VoIP telephone 108. The invention, however, is not limited to these identifiers. In an embodiment in which the user authentication protocol is the 802.1x standard, then each authentication session is identified by a User-Name. In such an embodiment, it is preferable that the User-Name include the VoIP telephone number 331, so that the VoIP telephone number 331 is provided to E911-enablement device 220 as part of the standard 802.1x user authentication protocol. The User-Name thus becomes the unique device identifier.

Although indicated as occurring after detection and interception of the 911 call packet stream, the geographic location information may be received from GPS receiver 240 prior to detection of the 911 call, and stored in memory if desired. Further, the optional authentication at block 410(e) may occur at any point prior to detection and interception of the 911 call packet stream, and stored in memory if desired. In one embodiment, Block 410(d) may include detecting a VoIP telephone 108 and authenticating the VoIP telephone 108 following detection. The authentication information may then be stored in memory. By way of example, the detection of the VoIP telephone may occur upon connection of the VoIP telephone to the E911-enablement device. Further, the geographic location information may be received from the GPS receiver following detection of the VoIP telephone, e.g., upon connection of the VoIP telephone to the E911-enablement device. This information may then be stored in memory until a 911 call is detected at block 410(a).

Method 400 further includes transmitting the 911 call packet stream comprising the geographic location information, and optional unique device identifier, to a Public Safety Answering Point (PSAP) of an E911 emergency service at block 420. At block 430, the E911 emergency service network 103 receives the 911 call packet stream including the geographic location information and the optional unique device identifier from E911-enablement device 220, and the E911 emergency service network 103 can thereby identify the geographic location of origination of the 911 call at block 440. In one embodiment, data may be transmitted using, e.g., suitable industry standard methods such as those described herein.

In accordance with this embodiment, in the event a 911 call originates with the VoIP telephone 108, the PSAP operator will have an accurate location and optionally a call-back telephone number or other unique device identifier for the VoIP telephone 108. The location information, as indicated by the geographic location information, is embodied as GPS information. The telephone number, as indicated by the unique device identifier, is embodied in the User-Name of the 802.1x authentication session.

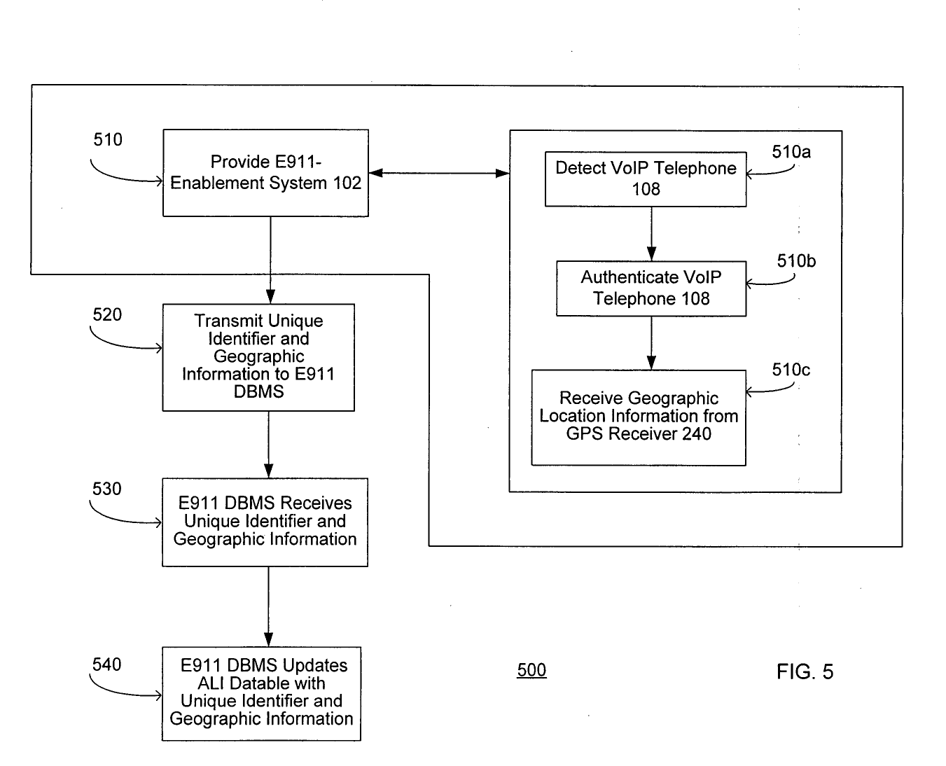

With reference to FIG. 5, another method 500 for supporting enhanced 911 (E911) emergency service in a data communications network is illustrated. Again, method 500 will be described with reference to the operating system of FIG. 1 and E911-enablement system 102, however the method is not so limited, and various substitutions are envisioned. Now, turning to FIG. 5, method 500 includes, at block 510, E911-enablement system 102 comprising E911-enablement device 220 coupled to GPS receiver 240, wherein E911-enablement system 102 is located in-line between VoIP telephone 108 and a network access point in communication with host network 104. E911-enablement device 220 is configured so as to: detect VoIP telephone 108 coupled to the network access point through E911-enablement device 220 at block 510(a); authenticate VoIP telephone 108 at block 510(b), wherein the authentication comprises receiving a unique device identifier related to the VoIP telephone; and receive geographic location information from said GPS receiver at block 510(c).

In one embodiment, the VoIP telephone may be authenticated using a standard authentication method described herein. By way of example, VoIP telephone 108 may be authenticated in accordance with the user authentication protocol. As part of the user authentication protocol, VoIP telephone 108 provides a unique device identifier to E911-enablement device 220. This unique device identifier may, e.g., comprise a physical (MAC) address 333 of VoIP telephone 108, an Internet Protocol (IP) address 335 of VoIP telephone 108, or a telephone number 331 of VoIP telephone 108. The invention, however, is not limited to these identifiers. In an embodiment in which the user authentication protocol is the 802.1x standard, then each authentication session is identified by a User-Name. In such an embodiment, it is preferable that the User-Name include the VoIP telephone number 331, so that the VoIP telephone number 331 is provided to E911-enablement device 220 as part of the standard 802.1x user authentication protocol. The User-Name thus becomes the unique device identifier.

Although indicated as occurring after authentication of the VoIP telephone, the geographic location information may be received from GPS receiver 240 following detection of the VoIP telephone at block 510(a), and stored in memory if desired. By way of example, the detection of the VoIP telephone may occur upon connection of the VoIP telephone to the E911-enablement device. Further, the geographic location information may be received from the GPS receiver following detection of the VoIP telephone, e.g., upon connection of the VoIP telephone to the E911-enablement device. This information may then be stored in memory.

Method 500 further includes transmitting the unique device identifier and the geographic location information to an E911 database management system (DBMS) at block 520. At block 530, the E911 DBMS 137 receives the unique device identifier and the geographic location information from E911-enablement device 220, and the E911 DBMS 137 can automatically update the ALI database 139 at block 540. In one embodiment, data may be transmitted using, e.g., suitable industry standard methods such as those described herein.

In an alternative embodiment, the above described method may be implemented to convey the unique device identifier and the geographic location identifier to LIS 110. LIS 110 can then periodically communicate with the E911 DBMS 137 to update the ALI database 139. This embodiment allows the host network administrator to track the location of a VoIP telephone 108 as it moves from access point to access point in host network 104.

In accordance with certain embodiments, the local PSAP 135 can access the updated ALI database by interfacing with the E911 database management system 137. In the event a 911 call originates with the VoIP telephone 108, the PSAP operator will have an accurate location and a call-back telephone number for the VoIP telephone 108. Again, the location information, as indicated by the geographic location information, is embodied in GPS information. The telephone number, as indicated by the unique device identifier, is embodied in the User-Name of the 802.1x authentication session.

In an alternative embodiment, the User-Name or unique device identifier and geographic location information may be transmitted to LIS 110. LIS 110 can then periodically communicate with the E911 database management system 137 to update the ALI database 139. This embodiment allows the host network administrator to track the location of a VoIP telephone 108 as it moves from access point to access point in host network 104.

Having described several embodiments, it will be recognized by those of skill in the art that various modifications, alternative constructions, and equivalents may be used without departing from the spirit of the invention. Further, various combinations of the described embodiments are envisioned. Accordingly, the above description should not be taken as limiting the scope of the invention, which is defined in the following claims.

What is claimed is:

1. A method of supporting enhanced 911 (E911) emergency service in a data communications network, said method comprising:
(a) providing an E911-enablement device coupled to a GPS receiver, wherein said E911-enablement device is located in-line between a Voice over Internet Protocol (VoIP) telephone and a network access point,
wherein said E911-enablement device:
(i) detects a 911 call;
(ii) intercepts said 911 call packet stream,
(iii) receives geographic location information from said GPS receiver, and
(iv) inserts said geographic location information into said 911 call packet stream; and
(b) transmitting said 911 call packet stream comprising said geographic location information to a Public Safety Answering Point (PSAP) of said E911 emergency service, thereby permitting said E911 emergency service to identify the geographic location of origination of said 911 call.

2. The method of claim 1, wherein said GPS receiver is integrated within said E911-enablement device, and said device is located in a line of sight of at least one GPS satellite such that the GPS receiver receives information from said at least one GPS satellite.

3. The method of claim 1, wherein said GPS receiver is remotely located from said E911-enablement device, and is in communication with said E911-enablement device via wired or wireless communication medium.

4. The method of claim 1, wherein said GPS receiver is equipped with an indicator that indicates the status of communication with at least one GPS satellite.

5. The method of claim 1, wherein following detection of said 911 call, but prior to transmission of said 911 call packet stream to said PSAP, said E911-enablement device further: authenticates said VoIP telephone, wherein said authenticating comprises receiving a unique device identifier related to said VoIP telephone, and inserts said unique device identifier into said 911 call packet stream.

6. The method of claim 5, wherein said authenticating of the VoIP telephone is in accordance with an IEEE 802.1x protocol.

7. The method of claim 5, wherein said authenticating of the VoIP telephone includes receiving a unique device identifier that comprises a telephone number of said VoIP telephone.

8. The method of claim 5, wherein said authenticating of the VoIP telephone includes receiving a unique device identifier that comprises an Internet Protocol (IP) address of said VoIP telephone.

9. The method of claim 5, wherein said authenticating of the VoIP telephone includes receiving a unique device identifier that comprises a media access control (MAC) address of said VoIP telephone.

10. A method of supporting enhanced 911 (E911) emergency service in a data communications network, said method comprising:
(a) providing an E911-enablement device coupled to a GPS receiver, wherein said E911-enablement device is located in-line between a Voice over Internet Protocol (VoIP) telephone and a network access point,
wherein said E911-enablement device:
(i) detects said Voice over Internet Protocol (VoIP) telephone coupled to said network access point through said E911-enablement device;
(ii) authenticates said VoIP telephone, wherein said authenticating comprises receiving a unique device identifier related to said VoIP telephone, and
(iii) receives geographic location information from said GPS receiver; and
(b) transmitting said unique device identifier and said geographic location information to an E911 database management system, thereby permitting said E911 database management system to store said geographic location information in association with said unique device identifier.

11. The method of claim 10, wherein said GPS receiver is integrated within said E911-enablement device, and said device is located in a line of sight of at least one GPS satellite such that the GPS receiver receives information from said at least one GPS satellite.

12. The method of claim 10, wherein said GPS receiver is remotely located from said E911-enablement device, and is in communication with said E911-enablement device via wired or wireless communication medium.

13. The method of claim 10, wherein said GPS receiver is equipped with an indicator that indicates the status of communication with at least one GPS satellite.

14. The method of claim 10, wherein said authenticating of the VoIP telephone is in accordance with an IEEE 802.1x protocol.

15. The method of claim 10, wherein said authenticating of the VoIP telephone includes receiving a unique device identifier that comprises a telephone number of said VoIP telephone.

16. The method of claim 10, wherein said authenticating of the VoIP telephone includes receiving a unique device identifier that comprises an Internet Protocol (IP) address of said VoIP telephone.

17. The method of claim 10, wherein said authenticating of the VoIP telephone includes receiving a unique device identifier that comprises a media access control (MAC) address of said VoIP telephone.

18. The method of claim 10, wherein said transmitting of said unique device identifier and said geographic location information to a local location information server (LIS) that is communicatively coupled to said E911 database management system.

19. An E911-enablement system comprising an E911-enablement device coupled to a GPS receiver, wherein said E911-enablement device comprises:
(a) at least one input port adapted for interfacing with a Voice over Internet Protocol (VoIP) telephone;
(b) at least one output port adapted for interfacing with a network access point; and
(c) control logic including computer implementable code for: receiving geographic location information from said GPS receiver; and transmitting at least said geographic location information to said outlet port for communication through said network access point.

20. The E911-enablement system of claim 19, wherein said GPS receiver is integrated within said E911-enablement device.

21. The E91-enablement system of claim 19, wherein said GPS receiver is remotely located from said E911-enablement device, and is in communication with said E911-enablement device via wired or wireless communication medium.

22. The E911-enablement system of claim 19, wherein said GPS receiver is equipped with an indicator that indicates the status of communication with at least one GPS satellite.

23. The E911-enablement system of claim 19, wherein said computer implementable code is further for: detecting a 911 call; intercepting a 911 call packet stream; inserting said geographic location information in said 911 call packet stream; and transmitting said 911 call packet stream including said geographic location information to said outlet port for communication through said network access point.

24. The E911-enablement system of claim 19, wherein said computer implementable code is further for: detecting and authenticating a VoIP telephone, wherein said authenticating comprises receiving a unique device identifier related to said VoIP telephone; and transmitting at least said unique device identifier to said outlet port for communication through said network access point.

25. The E911-enablement system of claim 24, wherein said authenticating of the VoIP telephone includes receiving a unique device identifier that comprises a telephone number of said VoIP telephone, an Internet Protocol (IP) address of said VoIP telephone, a media access control (MAC) address of said VoIP telephone, or a combination thereof.
